(19) United States
(12) Patent Application Publication
(10) Pub. No.: US 2011/0028354 A1
(43) Pub. Date: Feb. 3, 2011

(54) Method of Stimulating Subterranean Formation Using Low pH Fluid Containing a Glycinate Salt

(76) Inventors: Hoang Van Le, Spring, TX (US); D. V. Satyanarayana Gupta, The Woodlands, TX (US)

Correspondence Address: JONES & SMITH , LLP, 2777 ALLEN PARKWAY, SUITE 1000, HOUSTON, TX, 77019, US

(21) Appl. No.: 12/821,750

(22) Filed: Jun. 23, 2010

Related U.S. Application Data
(63) Continuation-in-part of application No. 12/368,555, filed on Feb. 10, 2009.

(51) Int. Cl. C09K 8/68

(52) U.S. Cl. 507/211

(57) ABSTRACT

Hydraulic fracturing is conducted by use of a well treatment fluid which contains a guar gum derivative as viscosifying or gelling polymer, an organic zirconate complex of a zirconium metal and an alkanol amine as crosslinking agent and a salt of a hydroxylated glycine as crosslinking delaying agent. The fluid is characterized by a low pH, generally greater than or equal to 3.0 and less than or equal to 5.0.

This application is a continuation-in-part application of U.S. application Ser. No. 12/368,555, filed on Feb. 10, 2009.

### FIELD OF THE INVENTION

The invention relates to a method of stimulating a subterranean formation penetrated by an oil or gas well by use of a low pH aqueous crosslinkable fluid containing a salt of a hydroxylated glycine which exhibits delayed crosslinking under downhole conditions.

### BACKGROUND OF THE INVENTION

Hydraulic fracturing is the process of enhancing oil and/or gas production from producing wells or enhancing the injection of water or other fluids into injection wells. Typically, a fracturing fluid is injected into the well, passing down the tubulars to the subterranean formation penetrated by the wellbore. The fluid is then pumped at rates and pressures that exceed the confining stresses in the formation, causing the formation to fail by inducing a fracture. This fracture originates at the wellbore and extends in opposite direction away from the wellbore. As more fluid is injected, the length, width and height of the fracture continue to extend. At a point, the width increases so that propping agents are added to the fluid and carried to the fracture and placed in the growing crack. The viscosity of such fluids is sufficient to adequately carry and place proppant into the formation.

Often, the fracturing fluid is composed of at least one water-soluble polymer which has been hydrated in water and which has been chemically modified with a crosslinking agent in order to increase fluid viscosity. Typical water-soluble polymers for use in fracturing fluids are those based on guar gum and include guar derivatives as well as cellulosic derivatives, xanthan and carrageenan. Commonly used crosslinking agents are those capable of providing borate ions as well as those agents which contain a metal ion such as aluminum, zirconium and titanium. Such viscosified fluids form three-dimensional gels.

Certain subterranean formations subjected to hydraulic fracturing are water sensitive. For instance, formations rich in swellable and migrating clays are water sensitive due to the presence of kaolinite, chlorite, illite and mixed layers of illite and smectite. It is therefore desired when treating such formations to minimize the amount of water in the fracturing fluid such as by energizing or foaming the fluid.

Energized or foamed fluids are particularly applicable to under-pressured gas reservoirs and wells which are rich in swellable and migrating clays. Fluids are typically energized with gases, such as nitrogen and carbon dioxide, to minimize the amount of liquids introduced into the formation and to enhance recovery of the fluids. In some cases, a mixture of such gases may be used. A mixture of two of such gases is referred to as a binary composition. Typically, fluids are considered energized if the volume percent of the energizing medium to the total volume of the treatment fluid (defined as “quality”) is less than 53%; they are considered as foams if the volume percent is greater than 53%.

In some instances, it may be desirable to add a non-gaseous foaming agent to the treatment fluid. Such agents often contribute to the stability of the resulting fluid and reduce the requisite amount of water in the fluid. In addition, such agents typically increase the viscosity of the fluid. Typical foaming agents include surfactants based on betaines, alpha olefin sulfonates, sulfate ethers, ethoxylated sulfate ethers and ethoxylates. Alpha olefin sulfonates are often preferred since they exhibit greater tolerance to oil contamination, such as that which originates from hydrocarbon based polymer slurries.

In those instances where it is desired to use a non-gaseous foaming agent in order to treat a water sensitive formation, it has been found that conventional crosslinking agents are less effective in the presence of certain foaming agents, such as alpha olefin sulfonates. The ultimate effect is a substantial loss of foam viscosity.

In addition to being water sensitive, formations which are rich in clays further are prone to permeability damage. It has been reported that low permeability sandstones are more compatible with low pH fluids than with high pH fluids. Two potentially different mechanisms for interaction with clays have been reported by use of high pH treatment: neutralization of the natural clay acidity and the attack of hydroxide on clays. The latter causes instability of certain clays, such as smectite. Low pH fluids are believed to cause less permeability damage. In addition, low pH fluids are believed to assist in hydrolysis of the polymer which results in better clean up of the fracture. Further, since low pH fluids can be energized or foamed with carbon dioxide and nitrogen, they are particularly applicable to under-pressure oil and gas reservoirs and wells with severe clay issues.

Typically fracturing fluids encounter high shear while they are being pumped through the tubing which penetrates the wellbore. It is therefore desirable that the fluid have a crosslink delay mechanism in order to minimize friction, i.e., avoid having to pump a highly viscous fluid in light of the resultant high horsepower requirements. In addition, a delay in crosslinking through a high-shear wellbore environment minimizes shear degradation and loss of fluid viscosity. Unfortunately, it is very difficult to control the delay of low pH fluids, particularly upon the addition of carbon dioxide.

It is desired therefore to develop a method of fracturing a formation using a low pH fracturing fluid having time-delay crosslinking. It is particularly desired to develop a method of fracturing a formation using a low pH fracturing fluid which contains a gas, including nitrogen and carbon dioxide, and which exhibits delayed crosslinking.

### SUMMARY OF THE INVENTION

An aqueous well treatment fluid containing a guar gum derivative, an organic zirconate complex and a hydroxylated glycine or salts thereof and characterized by a low pH minimizes permeability damage, exhibits excellent time delayed crosslinking and is particularly effective when used with a gas. The pH of the well treatment fluid is greater than or equal to 3.0 and less than or equal to 5.0.

The organic zirconate complex is composed of a zirconium metal and an alkanol amine. The organic zirconate complex is preferably contained in an alcohol solvent. In a preferred embodiment, the crosslinking agent is an amine zirconium complex in an alcohol solvent, such as propanol.

The guar gum derivative acts as the viscosifying polymer or gelling agent and is preferably a carboxyalkyl guar or a hydroxyalkylated guar. Preferred are carboxymethyl guar, hydroxypropyl guar, hydroxyethyl guar, hydroxybutyl guar and carboxymethylhydroxypropyl guar. Preferably the hydroxyalkylated guar has a molecular weight of about 1 to about 3 million. The Degree of Substitution of the carboxylated guar is typically between from about 0.08 to about 0.18 and the hydroxypropyl content of the hydroxyalkylated guar is typically between from about 0.2 to about 0.6.

The hydroxylated glycine, used as the crosslinking delay agent, is preferably N,N-bis(2-hydroxyethyl)glycine.

In a preferred embodiment, the crosslinking delay agent is a salt of a hydroxylated glycine, including salts of N,N-bis(2-hydroxyethyl)glycine. Preferred salts are alkali metal salts, such as sodium and potassium; alkaline earth metal salts, such as calcium and magnesium; transition metals, such as copper, zinc, zirconium and titanium; and ammonium.

The crosslinker may be delayed at low pH with or without a gaseous foaming agent, like carbon dioxide or nitrogen.

The fluid may contain a buffering agent or may be buffered by use of a gaseous foaming agent. The fluid preferably contains a buffering agent when a gaseous foaming agent is not used or when a non-buffering gaseous foaming agent, such as nitrogen, is used. When a buffering agent is present in the fluid, the pH of the fluid is typically between from about 4.0 to about 4.8, preferably from about 4.45 to about 4.8. Suitable buffering agents include weak organic acids. When used with a gaseous foaming agent, such as carbon dioxide, the pH of the aqueous fluid is as low as 3.7.

A non-gaseous foaming agent may be further be used. The non-gaseous foaming agent may amphoteric, cationic or anionic.

The well treatment fluid may be prepared on location using a high shear foam generator or may be shipped to the desired location.

### BRIEF DESCRIPTION OF THE DRAWINGS

In order to more fully understand the drawings referred to in the detailed description of the present invention, a brief description of each drawing is presented, in which:

FIG. 1 depicts the pressure differential over time for energized fluids within the scope of the invention.

FIG. 2 depicts the pressure differential over time for non-energized fluids within the scope of the invention.

FIG. 3 is a foam flow loop used to measure the viscosity of foamed or energized fluids as discussed in the Examples.

FIG. 4 illustrates the increased crosslinking delay time exhibited by a fluid containing a hydroxylated glycine versus a fluid which does not contain a hydroxylated glycine.

FIG. 5 illustrates the rheological characteristics of a low pH CO₂ foam fluid containing a guar gum and an organic zirconate crosslinking agent.

FIG. 6 illustrates the rheological characteristics of a low pH CO₂ foam fluid containing guar gum, an organic zirconate crosslinking agent and a hydroxylated glycine crosslinking delaying agent.

FIG. 7 illustrates the increased crosslinking delay time exhibited by a fluid containing the sodium salt of hydroxymethyl glycine.

FIG. 8 illustrates the effect of the loadings of the sodium salt of hydroxymethyl glycine on the rheological stability of a fluid over a 3 hour period.

### DETAILED DESCRIPTION OF THE PREFERRED EMBODIMENTS

Hydraulic fracturing is effectuated by use of a well treatment fluid which contains a guar gum derivative as viscosifying or gelling polymer, an organic zirconate complex as crosslinking agent and a hydroxylated glycine as crosslinking delaying agent. The organic zirconate complex is preferably composed of a zirconium metal and an alkanol amine.

The gelling agent is preferably a guar gum derivative, preferably a carboxyalkyl guar or a hydroxyalkylated guar.

Exemplary of hydroxyalkylated guars are hydroxypropyl guar (HPG), hydroxyethyl guar (HEG) and hydroxybutyl guar (HBG) as well as modified hydroxyalkylated guars such as carboxyalkylhydroxypropyl guar like carboxymethylhydroxypropyl guar (CMHPG). CMHPG is often most preferred due to its ease of hydration, availability and tolerance to hard water.

Preferably the hydroxyalkylated guar has a molecular weight of about 1 to about 3 million. The carboxyl content of the hydratable polysaccharides is expressed as Degree of Substitution (“DS”) and ranges from about 0.08 to about 0.18 and the hydroxypropyl content is expressed as Molar Substitution (MS) (defined as the number of moles of hydroxyalkyl groups per mole of anhydroglucose) and ranges between from about 0.2 to about 0.6.

Preferred as the carboxyalkyl guars is carboxymethyl guar. Carboxyalkyl guars include those which contain carboxylate groups anionically charged except in strong acid. These anionically charged groups tend to repel away from one another. The carboxyalkyl guar can be obtained in many ways, including a) using premium grade guar as the starting material to which the anionic groups are chemically added; and/or b) selecting processing parameters that provide better uniformity in placing the anionic substituents on the guar polymer backbone; and/or c) additional processing steps, including ultrawashing to remove impurities and refine the polymer. Preferred polymers include those guars having randomly distributed carboxymethyl groups including those commercially sold by Benchmark Chemical Company of Houston, Tex.

Further preferred as the viscosifying polymer in the invention are those polymers available from BJ Services Company as “GW45” (CMG), “GW32” (HPG) and “GW38” (CMHPG). Slurried counterparts of these polymers may also be used and are available from BJ Services Company as “XLFC2” (HPG), “XLFC2B” (HPG), “XLFC3” (CMPHG) “XLFC3B” (CMHPG), “VSP1” (CMG), and “VSP2” (CMG).

Typically, the amount of viscosifying polymer employed is between from about 15 to about 50, preferably from about 20 to about 30, pounds per 1,000 gallons of water in the fluid.

The crosslinking agent for use in the invention is an organic zirconate complex consisting of zirconium metal and an alkanol amine, such as triethanolamine. The organic zirconate complex is preferably contained in an alcohol solvent, preferably ethanol or propanol. Such crosslinking agents significantly increase the fluid viscosity at higher temperature. In a preferred embodiment, the crosslinking agent is an amine zirconium complex in an alcohol solvent, such as propanol. The amount of zirconium can range from 15 ppm zirconium (as ZrO₂) to 4910 ppm zirconium (as ZrO₂). The weight ratio of crosslinking agent in the alcohol solvent is typically between from about 40% to about 70%. Especially preferred are those organic zirconate complexes commercially available from Du Pont as Tyzor® zirconates.

The amount of crosslinking agent present in the aqueous fluid is that amount required to effectuate gelation or viscosification of the fluid at or near the downhole temperature of the targeted area, typically between from about 0.5 gpt to about 5 gpt based on the liquid volume of the aqueous fluid.

The crosslinking delaying agents, when used, is that desirous to delay or inhibit the effects of the crosslinking agent at the low pH and thereby allow for an acceptable pump time of the fluid at lower viscosities. Thus, the crosslinking delaying agent inhibits crosslinking of the crosslinking agent until after the well treatment fluid is placed at or near the desired location in the wellbore.

The crosslinking delay agent for use in the invention is a hydroxylated glycine as well as salts of hydroxylated glycines. Suitable salts include alkali metals, such as sodium and potassium; alkaline earth metals, such as calcium and magnesium, transition metals, such as copper, zinc, zirconium and titanium; and ammonium. Sodium salts of hydroxylated glycines are especially preferred.

The hydroxylated glycine is preferably a glycine having a hydroxyalkyl substituent group, such as hydroxyethyl. In a preferred embodiment, the hydroxylated glycine is N,N-bis(2-hydroxyethyl)glycine. Salts of N,N-bis(2-hydroxyethyl)glycine, such as the sodium salt, are also preferred.

The crosslink delay agent present in the aqueous fluid is that amount sufficient to effectuate the desired delay at surface conditions, typically between 0 gpt to about 4 gpt of the liquid volume of the aqueous fluid.

The crosslinker may be delayed at low pH with or without a gaseous foaming agent like carbon dioxide or nitrogen.

The pH of the aqueous well treatment fluid defined herein is greater than or equal to 3.0 and less than or equal to 5.0. Typically, the pH of the aqueous fluid is from about 3.6 to about 4.7. The low pH of the fluid is of great benefit in breaking down the polymeric structure of the viscosifying polymer of the fluid and thus is of great benefit during clean-up.

The fluid may contain a buffering agent or the fluid may be buffered by use of a gas. When a buffering agent is added to the fluid, the pH of the fluid is typically between from about 4.0 to about 4.8, preferably from about 4.45 to about 4.8. While any acid/acid salt combination which is capable of maintaining the well treatment composition to the desired pH may be used as buffering agent, weak organic acids and associated salts, such as acetic acid/sodium acetate, are particularly preferred.

The low pH of the fluid is further highly compatible with foaming gases. As such, the well treatment fluid is of great benefit to low pressurized reservoir wells since it enhances oil pressure and thus increases productivity of the well. When used with a foaming gas for buffering, the pH of the aqueous fluid is typically lower 3.7 and may be as low as 3.0. In a preferred embodiment, the pH of the aqueous fluid is between 3.7 and 4.0 when a foaming gas is used.

A non-gaseous foaming agent may further be used and is often desirable when a gaseous foaming agent is not used. The non-gaseous foaming agent may be amphoteric, cationic or anionic. Suitable amphoteric foaming agents include alkyl betaines, alkyl sultaines and alkyl carboxylates.

Suitable anionic foaming agents include alkyl ether sulfates, ethoxylated ether sulfates, phosphate esters, alkyl ether phosphates, ethoxylated alcohol phosphate esters, alkyl sulfates and alpha olefin sulfonates. Preferred as alpha-olefin sulfonates are salts of a monovalent cation such as an alkali metal ion like sodium, lithium or potassium, an ammonium ion or an alkyl-substituent or hydroxyalkyl substitute ammonium in which the alkyl substituents may contain from 1 to 3 carbon atoms in each substituent. The alpha-olefin moiety typically has from 12 to 16 carbon atoms.

Preferred alkyl ether sulfates are also salts of the monovalent cations referenced above. The alkyl ether sulfate may be an alkylpolyether sulfate and contains from 8 to 16 carbon atoms in the alkyl ether moiety. Preferred as anionic surfactants are sodium lauryl ether sulfate (2-3 moles ethylene oxide), C₈-C₁₀ ammonium ether sulfate (2-3 moles ethylene oxide) and a C₁₄-C₁₆ sodium alpha-olefin sulfonate and mixtures thereof. Especially preferred are ammonium ether sulfates.

Suitable cationic foaming agents include alkyl quaternary ammonium salts, alkyl benzyl quaternary ammonium salts and alkyl amido amine quaternary ammonium salts.

Preferred as foaming agent are alkyl ether sulfates, alkoxylated ether sulfates, phosphate esters, alkyl ether phosphates, alkoxylated alcohol phosphate esters, alkyl sulfates and alpha olefin sulfonates.

The well treatment fluid may further contain a complexing agent, gel breaker, surfactant, biocide, surface tension reducing agent, scale inhibitor, gas hydrate inhibitor, polymer specific enzyme breaker, oxidative breaker, buffer, clay stabilizer, acid or a mixture thereof and other well treatment additives known in the art. The addition of such additives to the fluid minimizes the need for additional pumps required to add such materials on the fly.

Further, acceptable additives may also include internal gel breakers. (An external breaker, applied after the well treatment fluid is pumped into the formation, may further be used especially at elevated temperatures.) Breakers commonly used in the industry may be used including inorganic, as well as organic, acids, such as hydrochloric acid, acetic acid, formic acid, and polyglycolic acid; persulfates, like ammonium persulfate; calcium peroxide; triethanolamine; sodium perborate; other oxidizers; antioxidizers; and mixtures thereof.

Further, the well treatment fluid may use an enzyme breaker. Typically, the enzyme breaker system is a mixture of highly specific enzymes which, for all practical purposes, completely degrade the backbone of the crosslinked polymer which is formed.

The well treatment fluid may be prepared on location using a high shear foam generator or may be shipped to the desired location.

Where the well treatment fluid is used as a fracturing fluid, the well treatment fluid may further contain a proppant. Suitable proppants include those conventionally known in the art including quartz sand grains, glass beads, aluminum pellets, ceramics, plastic beads and ultra lightweight (ULW) particulates such as ground or crushed shells of nuts like walnut, coconut, pecan, almond, ivory nut, brazil nut, etc.; ground and crushed seed shells (including fruit pits) of seeds of fruits such as plum, olive, peach, cherry, apricot, etc.; ground and crushed seed shells of other plants such as maize (e.g., corn cobs or corn kernels), etc.; processed wood materials such as those derived from woods such as oak, hickory, walnut, poplar, mahogany, etc., including such woods that have been processed by grinding, chipping, or other form of particalization, processing, etc.

Further the proppant may include porous ceramics or organic polymeric particulates. The porous particulate material may be treated with a non-porous penetrating material, coating layer or glazing layer. For instance, the porous particulate material may be a treated particulate material, as defined in U.S. Patent Publication No. 20050028979 wherein (a) the ASG of the treated porous material is less than the ASG of the porous particulate material; (b) the permeability of the treated material is less than the permeability of the porous particulate material; or (c) the porosity of the treated material is less than the porosity of the porous particulate material.

When present, the amount of proppant in the well treatment fluid is typically between from about 0.5 to about 12.0, preferably between from about 1 to about 8.0, pounds of proppant per gallon of well treatment fluid.

Exemplary of an operation using the fluid is that wherein the crosslinking agent is mixed into a solution containing the viscosifying polymer, crosslinking delay agent and, when used, a non-gaseous buffering agent and the desired fluid viscosity is generated. In the case where a foam fluid is desired, the non-gaseous foaming agent may be added to the polymer solution prior to the addition of the crosslinking agent and crosslinking and delay agent. When desired, carbon dioxide, nitrogen or a mixture thereof may then be added. The fluid to which the crosslinking agent is added may further contain a low pH buffer when nitrogen gas is used to form the foam fluid.

The fracturing fluid may be injected into a subterranean formation in conjunction with other treatments at pressures sufficiently high enough to cause the formation or enlargement of fractures or to otherwise expose the proppant material to formation closure stress. Such other treatments may be near wellbore in nature (affecting near wellbore regions) and may be directed toward improving wellbore productivity and/or controlling the production of fracture proppant.

The following examples are illustrative of some of the embodiments of the present invention. Other embodiments within the scope of the claims herein will be apparent to one skilled in the art from consideration of the description set forth herein. It is intended that the specification, together with the examples, be considered exemplary only, with the scope and spirit of the invention being indicated by the claims which follow.

All percentages set forth in the Examples are given in terms of weight units except as may otherwise be indicated.

### EXAMPLES

### Example 1

A gel was prepared by adding 7.5 ml of a polymer slurry containing the equivalent of 3.6 g of carboxymethyl guar having a degree of substitution (DS) of 0.17 to one liter of vigorously stirred tap water. The fluid was also treated with 1.0 ml of a 50% (by wt) solution of tetramethyl ammonium chloride and 5.0 ml of an acetic acid sodium acetate buffer designed for a pH of 4.5.

The speed of a Waring blender was adjusted to 1500 rpm and 250 grams of the gel was then poured into the blender. Blender jars were then inserted into the blender and mixing was started and a stable vortex was formed with the nut of the blades being visible. After approximately 1 minute, zirconium N,N-bis 2-hydroxy ethyl glycine (ZrBHEG) as crosslinking delaying agent was added and the pH of the solution was then recorded. Approximately 0.40 ml of a zirconium complex of alkanol amine in propanol, commercially available as Tyzor-223 from E.I. DuPont de Nemours and Company, was then injected into the blender. The amount of time for the gel to cover the nut on the blade of the blender jar and the vortex to remain closed was then measured. This may be defined as the vortex closure time (VCT) and represents the initiation of crosslinking The time for the gel to form a crown or dome-like surface on top of the blender jar nut is referred to as the crown time and represents complete crosslinking. The pH of the crosslinked fluid was then measured. The results are set forth in Table I below:

TABLE I

| [ZrBHEG], | Linear | Vortex | Crown, | xlinked | Final |
|---|---|---|---|---|---|
| gpt | pH | Closure, m:s | m:s | pH | Temp., ° F. |
| — | 4.48 | 0:22 | 0:51 | 4.67 | 68.4 |
| 0.25 | 4.51 | 0:24 | 1:10 | 4.7 | 68.8 |
| 0.75 | 4.54 | 0:39 | 2:08 | 4.70 | 69.4 |
| 1.5 | 4.56 | 1:09 | >5:00 | 4.73 | 71.3 |

This results establish the effectiveness of ZrBHEG as a delay agent in controlling the crosslinking rate of a fluid system.

### Example 2

This Example illustrates the effectiveness of the delay agent to fluid friction pressure when injecting the fluid through a foam loop with multiple pipe sizes.

The crosslinking delay efficiency of an aqueous fluid prepared in accordance with the invention was determined using a single pass foam rheometer. To measure early time, the heated coil section was bypassed and run directly through the capillary viscometer section. Each of the five tubes of the capillary viscometer section had a pressure transducer to measure the differential pressure and to calculate n′, K and viscosity.

To create a baseline in order to compare the pressures, a liner gel with no crosslinker was run through the rheometer first. A 20 ppt and a 40 ppt gel were passed through the system with and without carbon dioxide. The next sets of tests were performed with the same gel concentrations but with optimized crosslinker loading. This provided the maximum upper and lower pressures through the rheometer. The next set of tests were prepared with the same 20 ppt and 40 ppt gel crosslinked but with the delay additive. These tests were performed with and without carbon dioxide.

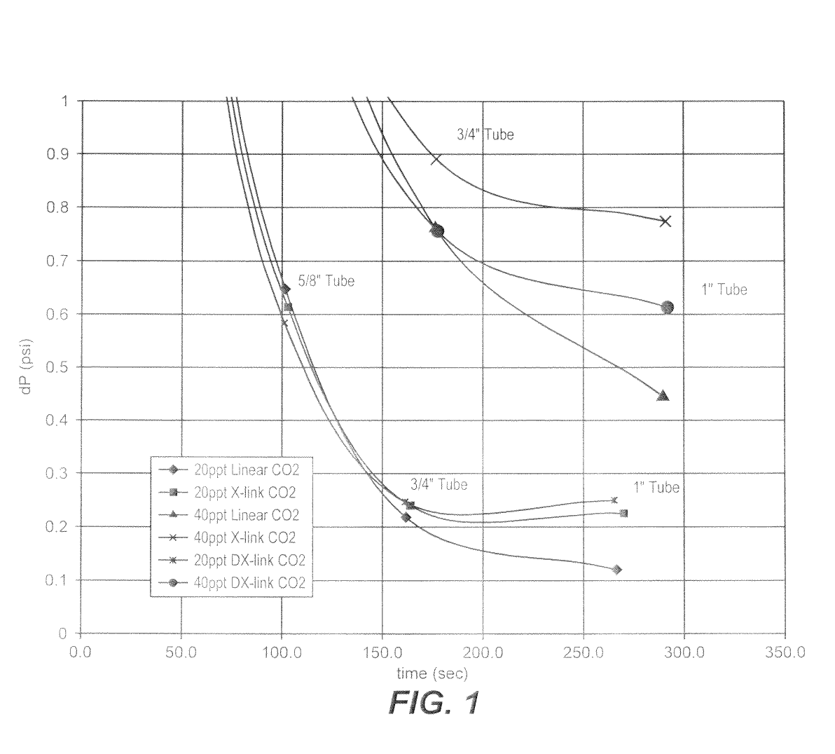

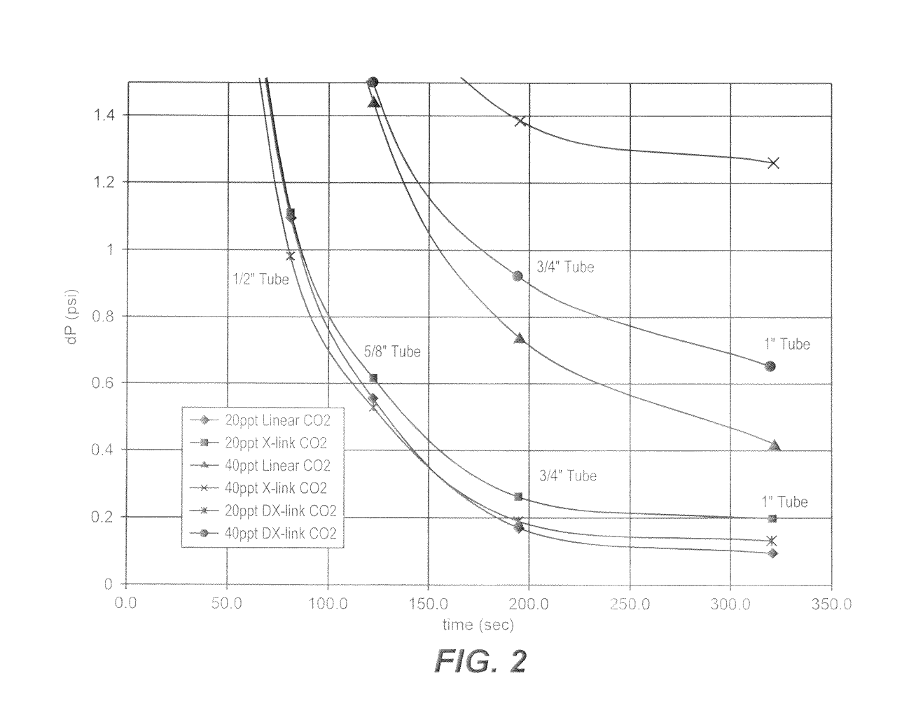

FIG. 1 depicts the results for energized fluids and FIG. 2 depicts the results for non-energized fluids. FIG. 1 and FIG. 2 show the crosslinked fluid follows the linear gel line in the first few tubes. It then deviates from the linear pressure line up to the fully crosslinked line. This occurs with or without carbon dioxide.

Examples 3 and 4 below illustrate the rheological stability of fluids in the absence of a gas and thus present a means of optimizing the liquid phase components. The method used for these Examples is defined in the American Petroleum Institute's ANSI/API Recommended Practice 13 M entitled “Recommended Practice for the Measurement of Viscous Properties of Completion Fluids”, First Edition, 2004. The tests were conducted using an automated Fann 50 viscometer equipped with an R1B5 cup (radius=1.8415 cm; length=14.240 cm) and bob (radius=1.5987 cm; length=8.7280 cm) assembly.

### Example 3

The fluid was prepared by adding 7.5 ml of a polymer slurry containing the equivalent of 3.6 g of carboxymethyl guar (DS=0.17) to one liter of vigorously stirred tap water. The fluid was also treated with 1.0 ml of a 50% (by wt) solution of tetramethyl ammonium chloride, 2.0 ml of 37% sodium thiosulfate and 5.0 ml of an acetic acid sodium acetate buffer designed for a pH of approximately 4.5. The fluid was then treated with 1.6 ml of zirconium complex of alkanol amine in propanol containing 5.58% zirconium calculated as ZrO₂. After stirring for 60 sec., 48 ml of fluid was syringed out of the mixer and injected into a rheometer cup, replaced on the Fann 50 and pressured to 300 psi with nitrogen gas. The fluid was initially subjected to a rate sweep using 102, 80.5, 60 and 38 sec⁻¹ shear rate while measuring stress at each rate for 30 sec. Afterward, the fluid was heated to 200° F. (94.4° C.) while shearing at 102 sec⁻¹. Measurements were recorded every 60 sec and the initial rate sweep repeated every 30 min. The rate and stress were used to calculate the Power Law Indices, n′ and K′, as well as the apparent viscosity at 40 and 100 sec⁻¹. The test continued at that temperature for 180 min., the time needed to pump most fracturing treatments.

### Example 4

The fluid for Example 4 was identical to that of Example 3, except that 0.75 ml of ZrBHEG was added to control the time that the fluid is viscous.

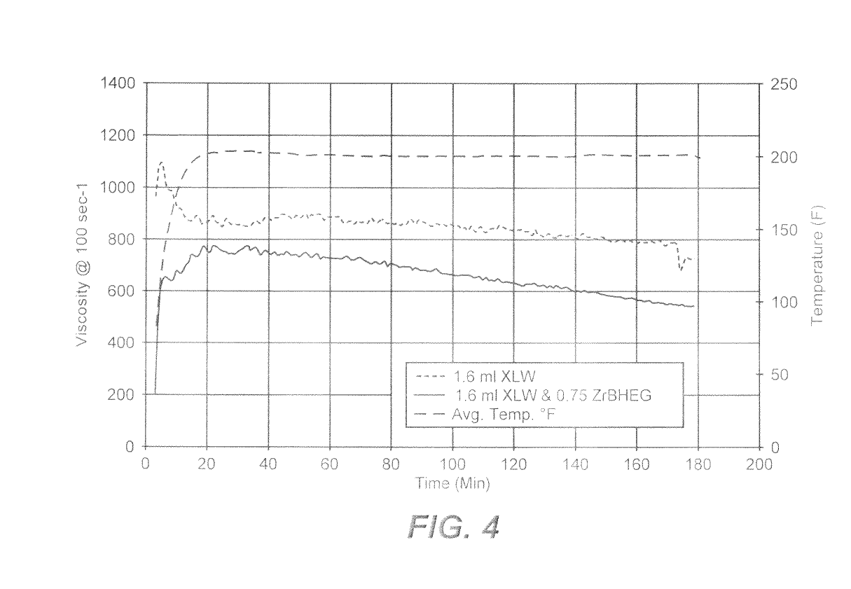

The results of the testing of Examples 3 and 4 are set forth in FIG. 4. FIG. 4 indicates that the fluid containing 0.75 ml of ZrBHEG exhibited longer delay time to form viscosity at room temperature. The stability of Examples 3 and 4 at the tested temperature was almost the same.

### Comparative Example 5

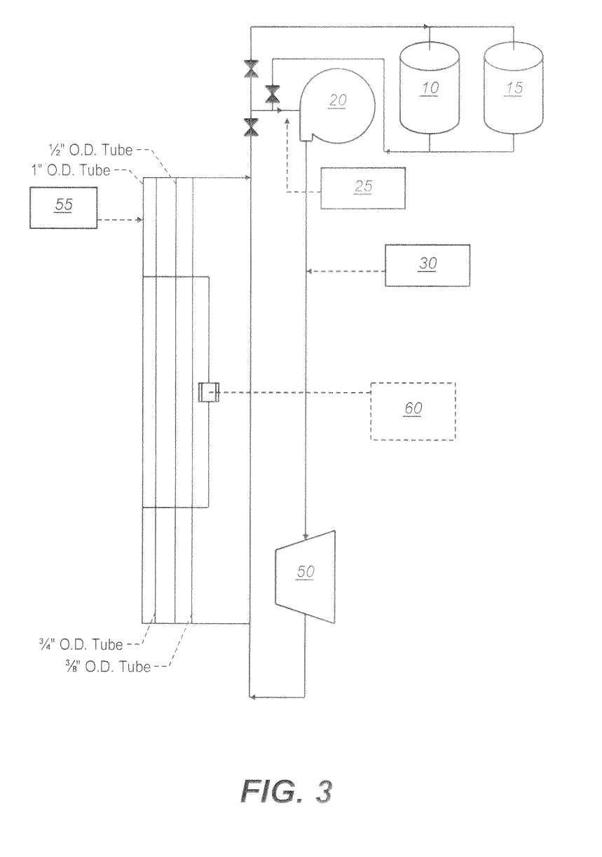

A fluid was prepared with 60% carbon dioxide as an energized fluid at 250° F. by mixing 567.7 ml of oil-based slurry containing 44% (by wt) carboxymethyl guar in 56.7 l of tap water containing 56.7 ml of a 50% solution of tetramethyl ammonium chloride and then adding 567.7 ml of GS-1L a gel stabilizer, commercially available from BJ Services Company. To the system was then added 567.7 ml of a foaming agent containing 1.1 l of 40 to 70% α-olefin sulfonate (available as FAW-4 from BJ Services Company). The fluid was then treated with 249.5 ml of the zirconium complex of alkanol amine in propanol and 60% (by vol.) carbon dioxide while pumping into the foam flow loop illustrated in FIG. 3.

The foam flow loop is a capillary tube viscometer used to measure the viscosity of foamed or energized fluids. There are essentially 10 elements in the foam loop. These elements include two 30 to 50 gallon mixing tanks 10 and 15, a triplex Cat pump 20 used to pump the fluid, an injection site using a syringe pump 25 for crosslinker addition as well as foam generator 30 in the form of a cross-fitting allowing injection at 90° to the fluid flow direction. The fluid is pre-conditioned by flowing it at a desired flow rate, with feedback from mass flow meter 50, through heated 1000 to 3000 ft. coils of 316 SS tubing. The viscosity was determined by measuring the pressure drop, flow rate and density across five different diameter and length tubes simultaneously. These pressure measurements provide up to five rates and stresses which are used to calculate the Power Law Indices, n′ and K′ and the viscosity at various shear rates. In addition, the measurements are taken by an automated, data acquisition unit and computer for real time viscosity analysis. A viewing cell was also built into the line to observe foam quality and may further be isolated to measure foam half-life. The loop also possessed a back-pressure regulator and data storage equipment.

The apparent viscosity was calculated from the Power Law Indices, n′ and K′, as defined in the American Petroleum Institute's ANSI/API Recommended Practice 13M entitled “Recommended Practice for the Measurement of Viscous Properties of Completion Fluids”, First Edition 2004. The viscosity was calculated at 40 and 100 sec⁻¹. In addition to viscosity, the foam was also ranked from 1-10 on foam stability based upon visual inspection using the following scale:

1-3 Extreme gas breakout. Severe slug flow;

4-5 Gas breakout at intermittent intervals. Usually will have larger bubble size;

6-7 A few bubbles of gas breakout, Good foam with small and medium bubble sizes; and

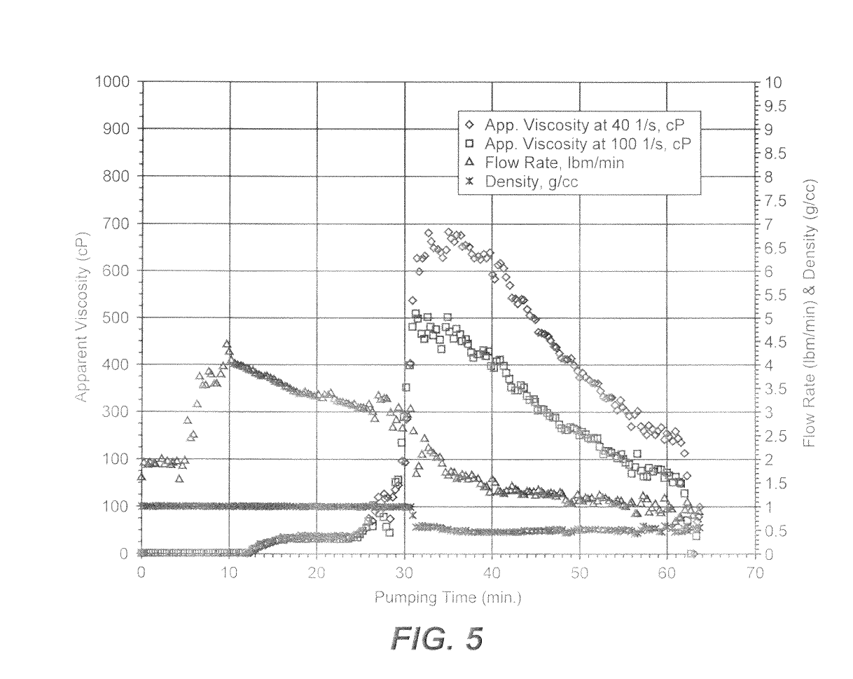

8-10 Good foam. No gas breakout. Small bubble size. Shaving cream texture. The test temperature was 250° F. The average viscosity at 40 sec⁻¹ was 404 cP and at 100 sec⁻¹ was 262 cP. The n′ was calculated to be 0.5353 and K′=0.04685 lb_{f}*sec^{n′}/ft². The foam stability rank was 5.5. The results are illustrated in FIG. 5.

### Example 6

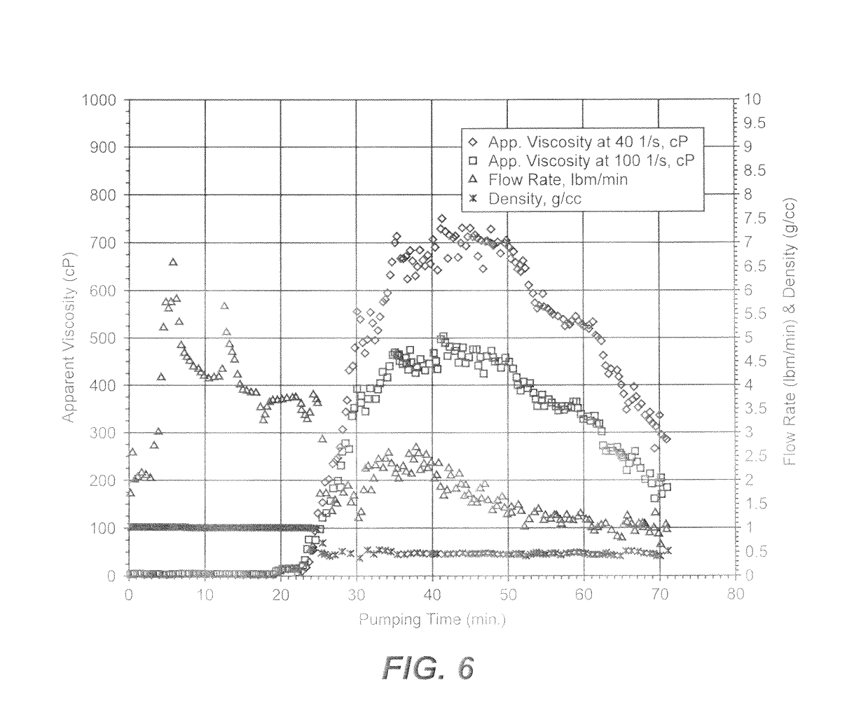

A fluid was prepared with 60% carbon dioxide as an energized fluid at 250° F. by mixing 567.7 ml of oil-based slurry containing 44% (by wt) carboxymethyl guar in 56.7 l of tap water containing 56.7 ml of a 50% solution of tetramethyl ammonium chloride and then adding 567.7 ml of GS-1L a gel stabilizer, commercially available from BJ Services Company. To the system was then added 567.7 ml of a foaming agent containing 1.1 l of 40 to 70% α-olefin sulfonate (available as FAW-4 from BJ Services Company) and 56.7 ml of ZrBHEG. The fluid was then treated with 249.5 ml of the zirconium crosslinking agent and 60% (by vol.) carbon dioxide while pumping into the foam flow loop of FIG. 3. The average viscosity at 40 sec⁻¹ was 583 cP and at 100 sec⁻¹ was 371 cP; the n′ was calculated to be 0.5017 and K′=0.07654 lb_{f}*sec^{n′}/ft². The foam stability rank was 6.0. The data obtained is further presented in FIG. 6. This fluid exhibits better rheology and better stability than the foam without the delayer (FIG. 5).

### Example 7

An aqueous fluid containing deionized water was prepared which also contained 1.0 gpt of a 50% (by wt) solution of trimethyl ammonium chloride (TMAC), 25 ppt carboxymethyl guar (CMG), commercially available as GW-45 from BJ Services Company, 2.35 ppt sodium bicarbonate, 4.0 gpt of a low pH buffer, commercially available as BF-18L from BJ Services Company, 1.40 gpt of an organic zirconium metal crosslinker and varying amounts of sodium hydroxymethyl glycine delayer (in a 50% solution in water). The CMG polymer was hydrated in water containing the TMAC solution. To the hydrated polymer solution, the buffer was added in a blender jar followed by the zirconium crosslinker and the sodium salt of hydroxymethyl glycine. delayer. The VCT and crown time were determined. The crosslinked fluid pH is also noted. The results are set forth in Table II below:

TABLE II

| Delayer, gpt | Vortex Closure, m:s | Crown, m:s | pH |
|---|---|---|---|
| — | 0:35 | 0:50 | 4.70 |
| 0.50 | 0:40 | 0:58 | 4.93 |
| 0.75 | 1:25 | 1:45 | 5.05 |
| 1.00 | 1:40 | 1:57 | 5.05 |
| 1.25 | 2:06 | 2:50 | 5.20 |
| 1.50 | 2:43 | 3:30 | 5.25 |
| 1.75 | 3:36 | 4:30 | 5.44 |
| 2.00 | 5:25 | 6:47 | 5.54 |

As shown in Table II, the addition of various loadings of sodium hydroxymethyl glycine controls the time of the CMG of the fracturing fluid to produce a crosslinked gel.

### Example 8

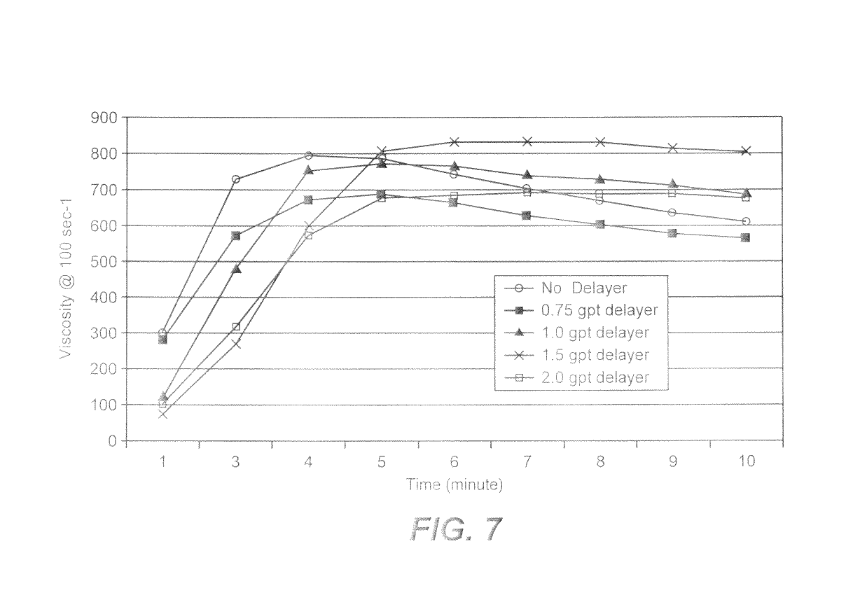

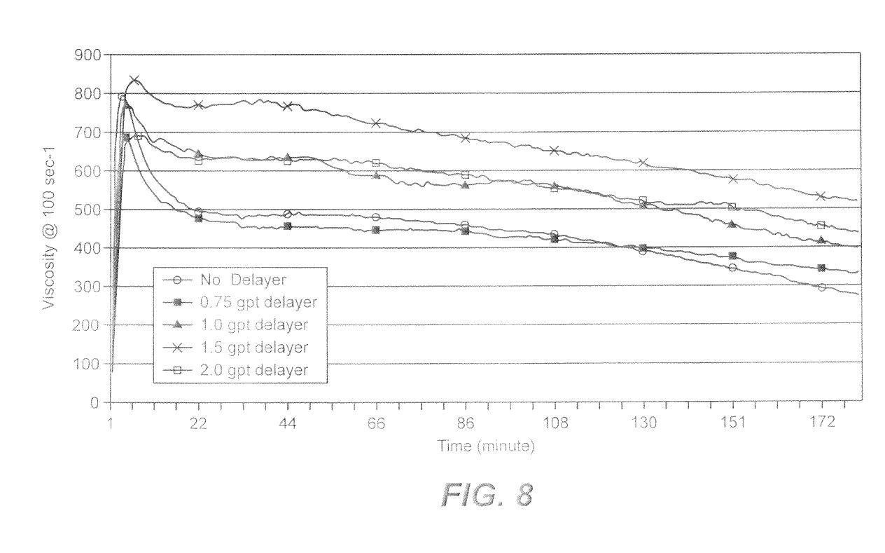

An aqueous fluid containing deionized water was prepared which also contained 25 ppt CMG, 1.0 gpt of a 50% (by wt) solution of TMAC, 4.0 gpt of a low pH buffer, commercially available as BF-18L from BJ Services Company, 3.0 ppt of sodium thiosulfate (gel stabilizer), 1.40 gpt of an organic zirconium metal crosslinker and varying amounts of sodium hydroxymethyl glycine delayer (in a 50% solution in water). The CMG polymer was hydrated in water containing the TMAC solution. To the hydrated polymer solution, the gel stabilizer and buffer were added in a blender jar followed by the zirconium crosslinker and sodium salt of hydroxymethyl glycine. FIG. 7 illustrates the effect of the various loadings of the sodium hydroxymethyl glycine solution on the early time gellation and production of the crosslinked gel. FIG. 8 illustrates the effect of the loadings of sodium hydroxymethyl glycine solution on the rheological stability of the fluid over a 3 hour period.

From the foregoing, it will be observed that numerous variations and modifications may be effected without departing from the true spirit and scope of the novel concepts of the invention.

What is claimed is:

1. A method of fracturing a subterranean formation penetrated by a well comprising the steps of:
(a) forming an aqueous fluid having a pH greater than or equal to 3.0 and less than or equal to 5.0, the aqueous fluid comprising:
(i) a guar gum derivative selected from the group consisting of carboxyalkyl guars and hydroxyalkylated guars;
(ii) an organic zirconate complex of a zirconium metal and an alkanol amine; and
(iii) a salt of a hydroxylated glycine; and
(b) pumping the fluid of step (a) down the well under sufficient pressure to fracture the subterranean formation.

2. The method of claim 1, wherein crosslinking of the aqueous fluid is delayed or inhibited until the aqueous fluid is placed at or near the fracturing site within the formation.

3. The method of claim 1 wherein the guar gum derivative is a hydroxyalkylated guar.

4. The method of claim 1, wherein the guar gum derivative is selected from the group consisting of carboxymethyl hydroxypropyl guar, hydroxypropyl guar and carboxymethyl guar.

5. The method of claim 1, wherein the organic zirconate complex is an amine zirconium complex.

6. The method of claim 1, wherein the organic zirconate complex is in an alcohol solvent.

7. The method of claim 6, wherein the alcohol solvent is propanol.

8. The method of claim 1, wherein the salt of the hydroxylated glycine is a sodium, potassium, calcium, magnesium, zinc, zirconium, titanium, iron or ammonium salt.

9. The method of claim 8, wherein the salt of hydroxylated glycine is a sodium salt.

10. The method of claim 9, wherein the salt of hydroxylated glycine is a sodium salt of N,N-bis(2-hydroxyethyl)glycine.

11. The method of claim 1, wherein the aqueous fluid further comprises a foaming gas.

12. The method of claim 11, wherein the foaming gas is nitrogen or carbon dioxide.

13. The method of claim 12, wherein the foaming gas is carbon dioxide and further wherein the pH of the aqueous fracturing fluid is less than or equal to 3.7.

14. The method of claim 1, wherein the pH of the aqueous fluid is buffered between from about 4.0 to about 4.8.

15. The method of clam 6, wherein the organic zirconate complex is an amine zirconium complex in an alcohol solvent.

16. A method of fracturing a subterranean formation penetrated by a well comprising the steps of:
(a) forming an aqueous fluid having a pH greater than or equal to 3.6 and less than or equal to 5.0, the aqueous fluid comprising:
(i) a guar gum derivative selected from the group consisting of hydroxyalkylated guars and carboxyalkyl guars;
(ii) an organic zirconate complex of a zirconium metal and an alkanol amine in an alcohol solvent; and
(iii) a salt of N,N-bis(2-hydroxyethyl)glycine; and
(b) pumping the fluid of step (a) down the well under sufficient pressure to fracture the subterranean formation.

17. The method of claim 16, wherein the salt of the N,N-bis(2-hydroxyethyl)glycine is present in the aqueous fluid in an amount sufficient to inhibit or delay crosslinking of the guar gum derivative and the organic zirconate complex until after the fluid has been pumped into the formation.

18. The method of claim 16, wherein the salt of N,N-bis(2-hydroxyethyl)glycine is a sodium, potassium, calcium, magnesium, zinc, zirconium, titanium, iron or ammonium salt.

19. The method of claim 18, wherein the salt of N,N-bis(2-hydroxyethyl)glycine hydroxylated glycine is a sodium salt.

20. The method of claim 16, wherein the aqueous fluid further comprises a foaming gas.

21. The method of claim 16, wherein the organic zirconate complex is an amine zirconium complex in an alcohol solvent.

22. A method of fracturing a subterranean formation penetrated by a well comprising the steps of:
(a) forming an aqueous fluid having a pH greater than or equal to 3.6 and less than or equal to 5.0, the aqueous fluid comprising:
(i) a guar gum derivative selected from the group consisting of carboxymethyl guar, carboxymethylhydroxypropyl guar and hydroxypropyl guar;
(ii) an amine zirconium complex in an alcohol solvent; and
(iii) a sodium salt of N,N-bis(2-hydroxyethyl)glycine; and
(b) pumping the fluid of step (a) down the well under sufficient pressure to fracture the subterranean formation.

23. The method of claim 22, wherein the foaming gas is carbon dioxide and further wherein the pH of the aqueous fluid is less than or equal to 3.7.

24. The method of claim 22, wherein the aqueous fluid further comprises a buffer and the pH of the aqueous fluid is between from about 4.0 to about 4.8.
